(19) United States
(12) Patent Application Publication
(10) Pub. No.: US 2026/0109825 A1
(43) Pub. Date: Apr. 23, 2026

(54) A COATED PACKAGING FILM SUITABLE FOR PACKAGES

(71) Applicant: Covestro (Netherlands) B.V., Geleen (NL)

(72) Inventors: Jurgen Scheerder, Buren (NL); Michael Villet, Maastricht (NL); Juan Guerrero, Sant Pere de Vilamajor (ES); Ludy van Hilst, Kaatscheuvel (NL); Johan Franz Gradus Antonius Jansen, Geleen (NL)

(21) Appl. No.: 19/117,441

(22) PCT Filed: Oct. 12, 2023
(86) PCT No.: PCT/EP2023/078434

§ 371 Date: Apr. 1, 2025

(30) Foreign Application Priority Data
Oct. 13, 2022 (EP) 22201363.3

(51) Int. Cl. C08J 7/04; B65D 65/42; C08F 220/18; C09D 5/18; C09D 133/10

(52) U.S. Cl. CPC C08J 7/0427; B65D 65/42; C08F 220/1804; C09D 5/18; C09D 133/10; C08J 2323/06; C08J 2433/10

(57) ABSTRACT

The present invention relates to a coated packaging film comprising:
(1) A heat sealable substrate having a heat sealable area and an opposite surface that is on the opposite side to the heat sealable area,
(2) A heat resistant coating disposed on at least a part of said opposite surface of the substrate,
wherein the heat resistant coating comprises:
(I) One or more polymers (I) having a glass transition temperature T_{g1} of at least 140° C., and
(II) One or more polymers (II) having a glass transition temperature T_{g2} of at most 50° C.,
wherein the difference between T_{g1} and T_{g2} is at least 100° C.,
wherein the T_{g1} and T_{g2} are determined with Differential Scanning Calorimetry as described in the description, and
wherein the substrate consists of at least 60 wt. % of polymer selected from the group consisting of polyethylene (PE), oriented polyethylene and any combination thereof, based on the total weight of the substrate.

The present invention relates to packaging films and in particular to heat sealable packaging films. The present invention further relates to a packaging article which is formed by the packaging film being heat sealed to itself or another packaging component.

Packaging films are usually to be formed into packaging articles, such as bags, pouches, and the like. Heat sealability is therefore an important functional property for packaging films, as it allows the films to be made into pouches, bags, etc., and also for the contents of the package, such as food, to be sealed inside. It is desirable for heat sealing to be executed at a high speed and with a broad operating window, to allow for good economics of production of sealed packages.

A commonly used heat sealing technology is “hot jaw” (also called “heat seal jaw” or “hot bar”) sealing, in which two film materials are clamped together between jaws, at least one of which is heated, until the contacting interfaces reach their seal temperature and a heat seal is formed. It is important that the seal is formed without the rest of the film softening or melting sufficiently to cause production problems, such as deformation or shrinking of the film leading to an unacceptable final package, or sticking or melting onto the heat sealing jaws causing interference with smoothly operating production. A heat sealable area refers to an area comprising sealable material and which is capable of forming a bond upon exposure to heat and pressure for a short dwell time, a process commonly known as heat sealing.

It is desirable to broaden the operating window in which the seals can be made without compromising the appearance or other performance properties of the packaging film. Furthermore, for speeding up the heat sealing process, the temperature of the heat sealable area should be brought to the sealing temperature as fast as possible, which can be facilitated by increasing the temperature of the heat seal bars of the heat sealing machine. However, when the temperature of the heat seal bars comes too high, the packaging film may be damaged which is of course not desired.

Further, there is an increasing need for recyclable packaging, and in particular for flexible film based packaging which is made of a high fraction of a single material type, and therefore is easier to recycle into high-value new material than multi-material packaging. An example of this is flexible film packaging made out of a majority of a single polymer family such as polyethylene (PE), polypropylene (PP), and polyethylene terephthalate (PET). Packaging films that incorporate biaxially-oriented polypropylene (BOPP) or biaxially-oriented polyethylene terephthalate (BOPET) films are often used in packaging, such as flexible film based packaging. Orientation is a common method to improve the mechanical and optical properties of polymers and is typically done in mono- or biaxial direction, using process such as machine-directed orientation, cast or blown processes. Such oriented films made from PE, PP, and PET are widely used in the packaging industry. For PE, the biaxial orientation improves properties such as clarity, stiffness, puncture resistance, tensile strength and shrinking of PE films. Biaxially-oriented polyethylene (BOPE) films are becoming more popular in the packaging industry, because BOPE has superior optics and printability. Furthermore, it is potentially cheaper than BOPET and BOPP. However, when designing packaging films made of a high fraction of a single material type, the selection of materials available for the heat-sealable area and the rest of the film is more limited. It is therefore more difficult to design such packaging with a broad operating window for heat sealing. Due to the lower heat stability of PE as compared to PP and PET, this is especially applicable when using majority PE packaging films. It has surprisingly been found that the heat resistant coating used in the present invention enables a broader operating window for heat sealing of substrates based on majority polyethylene, i.e. enables increasing the heat-sealing temperature at which visual deformation/damage occurs, while also not preventing a heat seal from forming.

The object of the present invention is to enhance the heat-sealing characteristics of packaging films that comprise a polyethylene based substrate.

This object has surprisingly been achieved by providing a coated packaging film comprising:
(1) A heat sealable substrate having a heat sealable area and an opposite surface that is on the opposite side to the heat sealable area,
(2) A heat resistant coating disposed on at least a part of said opposite surface of the substrate,
wherein the heat resistant coating comprises:
(I) One or more polymers (I) having a glass transition temperature T_{g1} of at least 140° C., and
(II) One or more polymers (II) having a glass transition temperature T_{g2}, that is lower than T_{g1}, and which is at most 50° C.,
wherein the difference between T_{g1} and T_{g2} is at least 100° C.,
wherein the T_{g1} and T_{g2} are determined with Differential Scanning Calorimetry as described herein, and
wherein the substrate consists of at least 60 wt. % of polymer selected from the group consisting of polyethylene (PE), oriented polyethylene and any combination thereof, based on the total weight of the substrate.

It has surprisingly been found that that the coated packaging film of the present invention allows to broaden the operating window in which the seals can be made without compromising the appearance or other performance properties of the packaging film. It has furthermore surprisingly been found that the coated packaging film of the present invention allows to increase the temperature of the heat seal bars and thereby increase the speed of the heat sealing process while protecting the substrate from being damaged (i.e. without causing increased distortion of the substrate of the coated packaging film) or from sticking to the heat seal bars in the heat sealing process. Examples of distortion are shrinking, melting (optionally resulting in sticking to the heat sealing bars), and/or wrinkling.

EP-A-675177 describes heat resistant coating compositions preferably containing a maleic anhydride copolymer and a (meth)acrylate (co)polymer as latex polymer, which coating is suitable to be used as an overcoat or overprint varnish for inks on packaging materials where the coating must have good heat resistance properties to avoid damaging the printed materials or is suitable to be used for paper goods such as paper plates and cups employed for hot foods. DE69728387T2 describes overprint varnishes for coating on paper or carboard. These publications do not disclose to use the coated substrate in a heat sealing process and also do not disclose or teach that the coating allows to broaden the operating window in which seals can be made at a heat sealable area that is located on the opposite surface where the coating is located. The leaflet “XIRAN® Heatboosters” of Polyscope describes that certain styrene maleic anhydride (SMA) copolymers, compounds, aqueous solutions and styrene maleic anhydride N-phenylmaleimide terpolymers provide heat boosting opportunities, but do not disclose or teach that these products can be used to improve the heat sealing characteristics of a substrate coated with a coating comprising a XIRAN® Heatbooster.

A first aspect of the current invention is a coated packaging film comprising:
(1) A heat sealable substrate having a heat sealable area and an opposite surface that is on the opposite side to the heat sealable area,
(2) A heat resistant coating disposed on at least a part of said opposite surface of the substrate,
wherein the heat resistant coating comprises:
(I) One or more polymers (I) having a glass transition temperature T_{g1} of at least 140° C., and
(II) One or more polymers (II) having a glass transition temperature T_{g2}, that is lower than T_{g1}, and which is at most 50° C.,
wherein the difference between T_{g1} and T_{g2} is at least 100° C.,
wherein the T_{g1} and T_{g2} are determined with Differential Scanning Calorimetry as described herein, and
wherein the substrate consists of at least 60 wt. % of polymer selected from the group consisting of polyethylene (PE), oriented polyethylene and any combination thereof, based on the total weight of the substrate.

A second aspect of the current invention is a substrate having a first surface, wherein said substrate comprises a heat resistant coating disposed on at least a part of said first surface, said substrate is intended to be used for producing a heat sealable packaging film having a heat sealable area on the opposite side of the heat resistant coating, wherein said heat resistant coating comprises:
(I) One or more polymers (I) having a glass temperature T_{g1} of at least 140° C., more preferably of at least 142° C., more preferably of at least 145° C., more preferably of at least 145° C., preferably of at least 150° C. and preferably of at most 260° C., more preferably of at most 250° C., more preferably of at most 240° C., more preferably of at most 230° C., more preferably of at most 220° C., and
(II) One or more polymers (II) having a glass transition temperature T_{g2}, that is lower than T_{g1}, and which is at most 50° C.,
wherein the difference between T_{g1} and T_{g2} is at least 100° C.,
wherein the T_{g1} and T_{g2} are determined with Differential Scanning Calorimetry as described in the description, and
wherein said substrate consists of at least 60 wt. % of polymer selected from the group consisting of polyethylene (PE), oriented polyethylene and any combination thereof, based on the total weight of the substrate.

A third aspect of the current invention is a packaging article obtained by heat sealing the coated packaging film of the first aspect of the invention to a heat sealable substrate, which may be the same coated packaging film or another heat sealable substrate, wherein the heat resistant coating is forming an outermost surface of the packaging article.

A fourth aspect of the current invention is a packaging film comprising the substrate according to the second aspect of the invention.

A fifth aspect is a packaging article obtained by heat sealing the packaging film according to the fourth aspect of the invention to a heat sealable substrate, which may be the same packaging film or another heat sealable substrate, wherein the heat resistant coating is forming an outermost surface of the packaging article.

### Polymer(s) (I) Having a Glass Transition Temperature T_{g1}

The T_{g1} should be selected sufficiently high such that when the coated packaging film is subjected to heat sealing conditions, the temperature at which distorting of said opposite surface is induced is increased.

The one or more polymers (I) have a glass temperature T_{g1}, determined with DSC as described herein, of at least 140° C., preferably of at least 142° C., more preferably of at least 145° C., more preferably of at least 150° C. and preferably of at most 260° C., more preferably of at most 250° C., more preferably of at most 240° C., more preferably of at most 230° C., more preferably of at most 220° C.

The thermally estimated mass content of the one or more polymers (I) having a glass transition temperature T_{g1}, relative to the total mass of polymers present in the heat resistant coating, is preferably at least 7.5 wt. %, even more preferably at least 10 wt. %, even more preferably at least 15 wt. %, even more preferably at least 20 wt. %, and the thermally estimated mass content of the one or more polymers (I), relative to the total mass of polymers present in the heat resistant coating, is preferably at most 85 wt. %, more preferably at most 80 wt. %, even more preferably at most 75 wt. %, even more preferably at most 70 wt. %, wherein the thermally estimated mass content of the one or more polymers with T_{g1} is determined with the method as described herein.

Preferably, the one or more polymers (I) are or are derived from a polymer comprising one or more monomers (A1) selected from the group consisting of styrene, substituted styrene, acrylic esters, methacrylic esters and itaconic esters, and
one or more monomers (A2) selected from the group consisting of acrylic acid, β-carboxy ethylacrylate, methacrylic acid, maleic acid, maleic anhydride and itaconic acid.

More preferably, the one or more monomers (A1) are selected from the group consisting of styrene and methacrylic esters, and the one or more monomers (A2) are selected from the group consisting of acrylic acid, methacrylic acid, maleic acid and maleic anhydride. More preferably, the one or more polymers (I) are or are derived from styrene/acrylic acid copolymers, preferably having a weight average molecular weight of from 2000 to 40000 g/mol (determined with the method as described herein) and/or having an acid value of from 70 to 300 mg KOH/gram styrene/acrylic acid copolymer.

As used herein, the acid value of a polymer is determined titrimetrically according to ISO 2114-2000.

Even more preferably, the one or more polymers (I) are or are derived from styrene/maleic anhydride (SMA) copolymers preferably having a weight average molecular weight of from 4000 to 150000 g/mol (determined with the method as described in the description) and/or having an acid value of from 130 to 500 mg KOH/gram SMA.

### Polymer(s) (II) Having a Glass Transition Temperature T_{g2}

The heat resistant coating further comprises one or more polymers having a glass transition temperature T_{g2}, that is lower than T_{g1}, wherein said T_{g2} is determined with Differential Scanning Calorimetry as described herein. The one or more polymers (II) have a glass temperature T_{g2} of at most 50° C., preferably of at most 40° C., more preferably of at most 30° C., even more preferably of at most 25° C., even more preferably of at most 20° C., even more preferably of at most 15° C., even more preferably of at most 10° C., even more preferably of at most 5° C.

The one or more polymers (II) preferably have a glass temperature T_{g2} of at least −60° C., more preferably of at least −50° C., even more preferably of at least −40° C., even more preferably of at least −30° C., even more preferably of at least −25° C.

The thermally estimated mass content of the one or more polymers (II) having a glass transition temperature T_{g2}, relative to the total mass of polymers present in the heat resistant coating, is preferably at least 15 wt. %, more preferably at least 17.5 wt. %, and the thermally estimated mass content of the one or more polymers (II) having a glass transition temperature T_{g2}, relative to the total mass of polymers present in the heat resistant coating, is preferably at most 90 wt. %, more preferably at most 85 wt. %, even more preferably at most 80 wt. %, wherein the thermally estimated mass content of the one or more polymers with T_{g2} is determined with the method as described herein.

Preferably, the one or more polymers (II) having a glass transition temperature T_{g2} comprises
(B1) one or more olefinically unsaturated monomers, and
(B2) optionally one or more carboxylic acid functional olefinically unsaturated monomers, different from (B1).

Monomer(s) (B1) are preferably selected from the group consisting of acrylic esters, methacrylic esters, arylalkylenes, itaconic esters and any mixture thereof. Monomer(s) (B2) if present are preferably selected from the group consisting of itaconic acid, itaconic anhydride, mono-alkylesters of itaconic acid, mono-aryl esters of itaconic acid, acrylic acid, methacrylic acid, β-carboxyethyl acrylate and combinations thereof, more preferably, monomer (B2) is acrylic acid and/or methacrylic acid and most preferably, monomer (B2) is acrylic acid. Preferably, at least 30 weight percent, more preferably at least 50 weight percent and even more preferably at least 70 weight percent of the total amount of monomers (B1) is selected from the group consisting of methyl methacrylate, n-butyl acrylate, n-butyl methacrylate, 2-ethyl hexyl acrylate, 2-octyl acrylate, styrene and mixtures of two or more of said monomers. Preferably, monomers (B1) are a combination of one or more acrylic esters and one or more methacrylic esters. The amount of monomer(s) (B2) in polymer (II) is preferably at most 3 wt. %, more preferably at most 2 wt. % and especially preferably 0 wt. %, and the amount of monomers (B1) is preferably at least 97 wt. %, even more preferably at least 98 wt. % and especially preferably 100 wt. %. The amounts of monomers (B1) and (B2) is given relative to the total weight of monomers charged in the polymerization to prepare the polymer (II). The amounts of monomers (B1) and (B2) preferably add up to 100 wt. %, i.e. the monomer(s) charged in the polymerization to prepare the polymer (II) preferably consist of monomer(s) (B1) and optionally of monomer(s) (B2).

The difference between T_{g1} and T_{g2} is at least 100° C., preferably at least 110° C., more preferably at least 120° C. and preferably at most 320° C., more preferably at most 295° C., more preferably at most 270° C., more preferably at most 245° C., more preferably at most 220° C.

The ratio of the amount of the one or more polymers (I) having a glass transition temperature T_{g1} to the amount of the one or more polymers (II) having a glass transition temperature T_{g2} is preferably at least 1:5, more preferably at least 1:4 and is preferably at most 5:1, more preferably at most 4:1, wherein said ratio is determined with the method as described in the description.

The summed amount of the thermally estimated mass content of the one or more polymers having a glass transition temperature T_{g1} and of the thermally estimated mass content of the one or more polymers having a glass transition temperature T_{g2} in the heat resistant coating is preferably at least 40 wt. %, more preferably at least 50 wt. %, relative to the total mass of polymers present in the heat resistant coating.

In a preferred embodiment of the present invention,
(i) the one or more polymers (I) having a glass temperature T_{g1} of at least 150° C. and of at most 210° C.,
(ii) the thermally estimated mass content of the one or more polymers (I), relative to the total mass of polymers present in the heat resistant coating, is at least 25 wt. % and at most 80 wt. %,
(iii) the one or more polymers (II) having a glass temperature T_{g2} of at least −30° C. and of at most 30° C., preferably of at most 10° C., more preferably of at most 5° C.,
(iv) the thermally estimated mass content of the one or more polymers (II), relative to the total mass of polymers present in the heat resistant coating, is at least 15 wt. % and at most 50 wt. %,
(v) the difference between T_{g1} and T_{g2} is at least 120° C. and at most 220° C., and
(vi) the ratio of the amount of the one or more polymers (I) having a glass transition temperature T_{g1} to the amount of the one or more polymers (II) having a glass transition temperature T_{g2} is at least 1:2.5 and at most 3.25:1.

The one or more polymers having a glass transition temperature T_{g2} are preferably prepared in the presence of the one or more polymers having a glass transition temperature T_{g1}. The T_{g2} is in this preferred embodiment of the invention preferably at most 20° C., more preferably at most 15° C., even more preferably at most 10° C., even more preferably at most 5° C.

The substrate of the coated packaging film is a polymer based substrate and the polymer include one or more polymers selected from the group consisting of polyethylene PE, oriented PE (for example machine-direction oriented PE (MDO PE), preferably BOPE), and any combination thereof.

The substrate of the coated packaging film consists of at least 60 wt. %, preferably of at least 70 wt. %, more preferably of at least 80 wt. % of polymer selected from the group consisting of polyethylene PE, oriented PE and any combination thereof, based on the total weight of the substrate. Preferably, the substrate consists of at least 60 wt. %, preferably of at least 70 wt. %, more preferably at least 80 wt. % of oriented polyethylene, based on the total weight of the substrate. The oriented polyethylene is preferably machine-direction oriented polyethylene, more preferably the oriented polyethylene is biaxially oriented polyethylene (BOPE).

The substrate of the coated packaging film may be a single layer or may include multiple layers.

The heat sealable area is preferably formed of a polymer, more preferably a polyethylene polymer. The heat sealable area may for example be an extruded film or blown film or a coating.

The heat resistant coating preferably has a dry thickness of at least 0.05 μm, preferably of at least 0.1 μm, more preferably of at least 0.25 μm, even more preferably of at least 0.4 μm and preferably of at most 25 μm, more preferably of at most 15 μm, even more preferably of at most 10 μm, even more preferably of at most 8 μm. One of the advantages of using a thin heat resistant coating layer is that it is possible to have the rest of the packaging film be majority of same polymer species (“mono-material”) thereby facilitating recycling.

In order to further enhance the recyclability, the weight fraction of the heat resistant coating, relative to the entire weight of the coated packaging film, is preferably at most 20 wt. %, more preferably at most 15 wt. %, more preferably at most 10 wt. %, more preferably at most 7.5 wt. %, more preferably at most 5 wt. %, more preferably at most 2.5 wt. %.

The heat resistant coating is preferably at least present in the critical areas which come in direct contact with the heat sealing bars and/or hot air during the heat sealing process. The heat resistant coating is preferably coextensive with at least 90% of the heat sealable area.

The coated packaging film may advantageously be used to form a packaging article, preferably a flexible packaging article, including pouches, bags, and sachets, wherein the heat resistant coating is forming an outermost surface of the packaging article. The present invention also relates to a packaging article obtained by heat sealing the coated packaging film of the first aspect of the invention to a heat sealable substrate, which may be the same coated packaging film or another heat sealable substrate, wherein the heat resistant coating is forming an outermost surface of the packaging article. For example, when the coated packaging film is used for making filled stand-up pouches, an exemplary method for production the packaging article comprises (i) folding coated packaging film into the right shape (optionally also making W-shaped fold forms gusset at bottom of pouch), (ii) sealing to form sides of the packaging article, thereby leaving one side open, (iii) cutting into individual pouches, (iv) filling the partly heat sealed pouches, and (iv) heat sealing the open side of the pouch that had not yet been heat sealed.

The invention is further defined by the set of exemplary embodiments as listed hereafter. Any one of the embodiments, aspects and preferred features or ranges as disclosed in this application may be combined in any combination, unless otherwise stated herein or if technically clearly not feasible to a skilled person.
[1] A coated packaging film comprising:
   (1) A heat sealable substrate having a heat sealable area and an opposite surface that is on the opposite side to the heat sealable area,
   (2) A heat resistant coating disposed on at least a part of said opposite surface of the substrate,
   wherein the heat resistant coating comprises:
   (I) One or more polymers (I) having a glass transition temperature T_{g1} of at least 140° C., and
   (II) One or more polymers (II) having a glass transition temperature T_{g2}, that is lower than T_{g1}, and which is at most 50° C.,
   wherein the difference between T_{g1} and T_{g2} is at least 100° C.,
   wherein the T_{g1} and T_{g2} are determined with Differential Scanning Calorimetry as described in the description.
[2] The packaging film according to embodiment [1], wherein the thermally estimated mass content of the one or more polymers (I) having a glass transition temperature T_{g1}, relative to the total mass of polymers present in the heat resistant coating, is at least 7.5 wt. %, preferably at least 10 wt. %, more preferably at least 15 wt. %, even more preferably at least 5 wt. %, and the thermally estimated mass content of the one or more polymers (I), relative to the total mass of polymers present in the heat resistant coating, is at most 85 wt. %, more preferably at most 80 wt. %, even more preferably at most 75 wt. %, even more preferably at most 70 wt. %, wherein the thermally estimated mass content of the one or more polymers with T_{g1} is determined with the method as described herein.
[3] The packaging film according to embodiment [1] or [2], wherein the one or more polymers (I) having a glass temperature T_{g1} of at least 142° C., more preferably of at least 145° C., even more preferably at least 150° C. and preferably at most 260° C., more preferably at most 250° C., even more preferably at most 240° C., even more preferably at most 230° C., more preferably at most 220° C.
[4] The packaging film according to any one of the embodiments [1] to [3], wherein the one or more polymers (I) are or are derived from a polymer comprising one or more monomers (A1) selected from the group consisting of styrene, substituted styrene, acrylic esters, methacrylic esters and itaconic esters, and one or more monomers (A2) selected from the group consisting of acrylic acid, β-carboxy ethylacrylate, methacrylic acid, maleic acid, maleic anhydride and itaconic acid.
[5] The packaging film according to embodiment [4], wherein the one or more monomers (A1) are selected from the group consisting of styrene and methacrylic esters, and the one or more monomers (A2) are selected from the group consisting of acrylic acid, methacrylic acid, maleic acid and maleic anhydride.
[6] The packaging film according to any one of the preceding embodiments [1] to [5], wherein the one or more polymers (I) are or are derived from styrene/maleic anhydride (SMA) copolymers preferably having a weight average molecular weight of from 4000 to 150000 g/mol, determined with the method as described in the description and/or having an acid value of from 130 to 500 mg KOH/gram SMA.
[7] The packaging film according to any one of the embodiments [1] to [6], wherein the one or more polymers (I) are or are derived from styrene/acrylic acid copolymers, preferably having a weight average molecular weight of from 2000 to 40000 g/mol, determined with the method as described in the description and/or having an acid value of from 70 to 300 mg KOH/gram styrene/acrylic acid copolymer.
[8] The packaging film according to any one of the embodiments [1] to [7], wherein the difference between T_{g1} and T_{g2} is at least 110° C., preferably at least 120° C. and preferably at most 320° C., more preferably at most 295° C., even more preferably at most 270° C., even more preferably at most 245° C., even more preferably at most 220° C.
[9] The packaging film any one of the embodiments [1] to [8], wherein T_{g2} is at least −60° C., preferably at least −50° C., more preferably at least −40° C., even more preferably at least −30° C., even more preferably at least −25° C., and preferably at most 40° C., more preferably at most 30° C., even more preferably at most 25° C., even more preferably at most 20° C., even more preferably at most 15° C., even more preferably at most 10° C., even more preferably at most 5° C.
[10] The packaging film according to any one of embodiments [1] to [9], wherein the thermally estimated mass content of the one or more polymers (II) having a glass transition temperature T_{g2}, relative to the total mass of polymers present in the heat resistant coating, is at least 15 wt. %, preferably at least 17.5 wt. %, and the thermally estimated mass content of the one or more polymers (II) having a glass transition temperature T_{g2}, relative to the total mass of polymers present in the heat resistant coating, is at most 90 wt. %, preferably at most 85 wt. %, more preferably at most 80 wt. %, wherein the thermally estimated mass content of the one or more polymers with T_{g2} is determined with the method as described in the description.
[11] The packaging film according to any one of the embodiments [1] to [10], wherein the ratio of the amount of the one or more polymers (I) having a glass transition temperature T_{g1} to the amount of the one or more polymers (II) having a glass transition temperature T_{g2} is at least 1:5, more preferably at least 1:4 and is preferably at most 5:1, more preferably at most 4:1, wherein said ratio is determined with the method as described in the description.
[12] The packaging film according to any one of embodiments [1] to [11], wherein
   (i) the one or more polymers (I) having a glass temperature T_{g1} of at least 150° C. and of at most 210° C.,
   (ii) the thermally estimated mass content of the one or more polymers (I), relative to the total mass of polymers present in the heat resistant coating, is at least 25 wt. % and at most 80 wt. %,
   (iii) the one or more polymers (II) having a glass temperature T_{g2} of at least −30° C. and of at most 30° C., preferably of at most 10° C., more preferably of at most 5° C.,
   (iv) the thermally estimated mass content of the one or more polymers (II), relative to the total mass of polymers present in the heat resistant coating, is at least 15 wt. % and at most 50 wt. %,
   (v) the difference between T_{g1} and T_{g2} is at least 120° C. and at most 220° C., and
   (vi) the ratio of the amount of the one or more polymers (I) having a glass transition temperature T_{g1} to the amount of the one or more polymers (II) having a glass transition temperature T_{g2} is at least 1:2.5 and at most 3.25:1.
[13] The packaging film according to any one of embodiments [1] to [12], wherein the one or more polymers (II) having a glass transition temperature T_{g2} comprises
   (B1) one or more olefinically unsaturated monomers, and
   (B2) optionally one or more carboxylic acid functional olefinically unsaturated monomers, different from (B1).
[14] The packaging film according to embodiment [13], wherein monomer(s) (B2) if present are selected from the group consisting of itaconic acid, itaconic anhydride, mono-alkylesters of itaconic acid, mono-aryl esters of itaconic acid, acrylic acid, methacrylic acid, β-carboxyethyl acrylate and combinations thereof, more preferably, monomer (B2) is acrylic acid and/or methacrylic acid and most preferably, monomer (B2) is acrylic acid; and/or monomer(s) (B1) are selected from the group consisting of acrylic esters, methacrylic esters, arylalkylenes, itaconic esters and any mixture thereof.
[15] The packaging film according to embodiment [13] or [14], wherein at least 30 weight percent, more preferably at least 50 weight percent and even more preferably at least 70 weight percent of the total amount of monomers (B1) is selected from the group consisting of methyl methacrylate, n-butyl acrylate, n-butyl methacrylate, 2-ethyl hexyl acrylate, 2-octyl acrylate, styrene and mixtures of two or more of said monomers.
[16] The packaging film according to any one of embodiments [13] to [15], wherein the amount of monomers (B2) in polymer B is at most 3 wt. %, even more preferably at most 2 wt. % and especially preferably 0 wt. %, and the amount of monomers (B1) is preferably at least 97 wt. %, even more preferably at least 98 wt. % and especially preferably 100 wt. %.
[17] The packaging film according to any one of embodiments [13] to [16], wherein (B1) is a combination of one or more acrylic esters and one or more methacrylic esters.
[18] The packaging film according to any one of embodiments [1] to [17], wherein the summed amount of the thermally estimated mass content of the one or more polymers having a glass transition temperature T_{g1} and of the thermally estimated mass content of the one or more polymers having a glass transition temperature T_{g2} in the heat resistant coating is at least 40 wt. %, more preferably at least 50 wt. %, relative to the total mass of polymers present in the heat resistant coating.
[19] The packaging film according to any one of embodiments [1] to [18], wherein the one or more polymers having a glass transition temperature T_{g2} are prepared in the presence of the one or more polymers having a glass transition temperature T_{g1}.
[20] The packaging film according to any one of the embodiments [1] to [19], wherein the substrate is a polymer based substrate and the polymer include one or more polymers selected from the group consisting of polyethylene PE, oriented PE (preferably BOPE), and any combination thereof.
[21] The packaging film according to any one of the embodiments [1] to [20], wherein the substrate consists of at least 60 wt. %, preferably at least 70 wt. %, more preferably of at least 80 wt. % of polymer selected from the group consisting of polyethylene (PE), oriented polyethylene and any combination thereof, based on the total weight of the substrate.
[22] The packaging film according to any one of the embodiments [1] to [21], wherein the substrate consists of at least 60 wt. %, preferably of at least 70 wt. %, more preferably at least 80 wt. % of oriented polyethylene, based on the total weight of the substrate.
[23] The packaging film according to any one of the embodiments [1] to [21], wherein the substrate consists of at least 60 wt. %, preferably of at least 70 wt. %, more preferably at least 80 wt. % of machine-direction oriented polyethylene, based on the total weight of the substrate.
[24] The packaging film according to any one of the embodiments [1] to [21], wherein the substrate consists of at least 60 wt. %, preferably of at least 70 wt. %, more preferably at least 80 wt. % of biaxially oriented polyethylene (BOPE), based on the total weight of the substrate.
[25] The packaging film according to any one of embodiments [1] to [24], wherein the heat resistant coating is obtained by (1) disposing an aqueous coating composition on at least a part of the substrate at the side of the substrate that is opposite to the side where the heat sealable area is located, and (2) drying the aqueous coating composition, affording the heat resistant coating on at least a part of the first surface of the substrate.
[26] The packaging film according to any one of embodiments [1] to [25], wherein the heat resistant coating has a dry thickness of at least 0.05 μm, preferably of at least 0.1 μm, more preferably of at least 0.25 μm, more preferably of at least 0.4 μm and preferably of at most 25 μm, more preferably of at most 15 μm, more preferably of at most 10 μm, more preferably of at most 8 μm.
[27] The packaging film according to any one of embodiments [1] to [26], wherein the heat resistant coating is at least present in the critical areas which come in direct contact with the heat sealing bars and/or hot air during the heat sealing process.
[28] The packaging film according to any one of embodiments [1] to [27], wherein the heat sealable area is formed of a polymer, preferably a polyethylene polymer.
[29] The packaging film according to any one of embodiments [1] to [28], wherein the substrate is a single layer or includes multiple layers.
[30] The packaging film according to any one of embodiments [1] to [29], wherein the heat sealable area is an extruded film or blown film or a coating.
[31] The packaging film according to any one of embodiments [1] to [30], wherein the packaging film is used to form a packaging article including pouches, bags, and sachets, wherein the heat resistant coating is forming an outermost surface of the packaging article.
[32] A packaging article obtained by heat sealing the coated packaging film according to any one of embodiments [1] to [31] to a heat sealable substrate, which may be the same coated packaging film or another heat sealable substrate, wherein the heat resistant coating is forming an outermost surface of the packaging article
[33] A substrate having a first surface, wherein said substrate comprises a heat resistant coating disposed on at least a part of said first surface, said substrate is intended to be used for producing a heat sealable packaging film having a heat sealable area on the opposite side of the heat resistant coating, wherein said heat resistant coating comprises
   (I) one or more polymers (I) having a glass temperature T_{g1} of at least 140° C., more preferably of at least 142° C., more preferably of at least 145° C., preferably of at least 150° C. and preferably of at most 260° C., more preferably of at most 250° C., more preferably of at most 240° C., more preferably of at most 230° C., more preferably of at most 220° C., and
   (II) one or more polymers (II) having a glass transition temperature T_{g2}, that is lower than T_{g1}, and which is at most 50° C.,
   wherein the difference between T_{g1} and T_{g2} is at least 100° C., wherein the T_{g1} and T_{g2} are determined with Differential Scanning Calorimetry as described in the description.
[34] The substrate according to embodiment [33], wherein the thermally estimated mass content of the one or more polymers (I) having a glass transition temperature T_{g1}, relative to the total mass of polymers present in the heat resistant coating, is at least 7.5 wt. %, preferably at least 10 wt. %, more preferably at least 15 wt. %, even more preferably at least 20 wt. %, and the thermally estimated mass content of the one or more polymers (I), relative to the total mass of polymers present in the heat resistant coating, is at most 85 wt. %, preferably at most 80 wt. %, more preferably at most 75 wt. %, even more preferably at most 70 wt. %, wherein the thermally estimated mass content of the one or more polymers with T_{g1} is determined with the method as described herein.
[35] The substrate according to any one of the embodiments [33] to [34], wherein the one or more polymers (I) are or are derived from a polymer comprising one or more monomers (A1) selected from the group consisting of styrene, substituted styrene, acrylic esters, methacrylic esters and itaconic esters, and one or more monomers (A2) selected from the group consisting of acrylic acid, B1-carboxy ethylacrylate, methacrylic acid, maleic acid, maleic anhydride and itaconic acid.
[36] The substrate according to embodiment [35], wherein the one or more monomers (A1) are selected from the group consisting of styrene and methacrylic esters, and the one or more monomers (A2) are selected from the group consisting of acrylic acid, methacrylic acid, maleic acid and maleic anhydride.
[37] The substrate according to any one of the preceding embodiments [35] to [36], wherein the one or more polymers (I) are or are derived from styrene/maleic anhydride (SMA) copolymers preferably having a weight average molecular weight of from 4000 to 150000 g/mol, determined with the method as described in the description and/or having an acid value of from 130 to 500 mg KOH/gram SMA.
[38] The substrate according to any one of the embodiments [33] to [37], wherein the one or more polymers (I) are or are derived from styrene/acrylic acid copolymers, preferably having a weight average molecular weight of from 2000 to 40000 g/mol, determined with the method as described in the description and/or having an acid value of from 70 to 300 mg KOH/gram styrene/acrylic acid copolymer.
[39] The substrate according to any one of the embodiments [33] to [38], wherein the difference between T_{g1} and T_{g2} is at least 110° C., preferably at least 120° C. and preferably at most 320° C., more preferably at most 295° C., even more preferably at most 270° C., even more preferably at most 245° C., even more preferably at most 220° C.
[40] The substrate according to any one of the embodiments [33] to [39], wherein T_{g2} is at least −60° C., preferably at least −50° C., more preferably at least −40° C., even more preferably at least −30° C., even more preferably at least −25° C., and preferably at most 40° C., more preferably at most 30° C., even more preferably at most 25° C., even more preferably at most 20° C., even more preferably at most 15° C., even more preferably at most 10° C.
[41] The substrate according to any one of embodiments [33] to [40], wherein the thermally estimated mass content of the one or more polymers (II) having a glass transition temperature T_{g2}, relative to the total mass of polymers present in the heat resistant coating, is at least 15 wt. %, preferably at least 17.5 wt. %, and the thermally estimated mass content of the one or more polymers (II) having a glass transition temperature T_{g2}, relative to the total mass of polymers present in the heat resistant coating, is at most 90 wt. %, preferably at most 85 wt. %, more preferably at most 80 wt. %, wherein the thermally estimated mass content of the one or more polymers with T_{g2} is determined with the method as described in the description.
[42] The substrate according to any one of the embodiments [33] to [41], wherein the ratio of the amount of the one or more polymers (I) having a glass transition temperature T_{g1} to the amount of the one or more polymers (II) having a glass transition temperature T_{g2} is at least 1:5, more preferably at least 1:4 and is preferably at most 5:1, more preferably at most 4:1, wherein said ratio is determined with the method as described in the description.
[43] The substrate according to any one of embodiments [33] to [42], wherein
   (i) the one or more polymers (I) having a glass temperature T_{g1} of at least 150° C. and of at most 210° C.,
   (ii) the thermally estimated mass content of the one or more polymers (I), relative to the total mass of polymers present in the heat resistant coating, is at least 25 wt. % and at most 80 wt. %,
   (iii) the one or more polymers (II) having a glass temperature T_{g2} of at least −30° C. and of at most 30° C., preferably of at most 10° C., more preferably at most 5° C.,
   (iv) the thermally estimated mass content of the one or more polymers (II), relative to the total mass of polymers present in the heat resistant coating, is at least 15 wt. % and at most 50 wt. %,
   (v) the difference between T_{g1} and T_{g2} is at least 120° C. and at most 220° C., and
   (vi) the ratio of the amount of the one or more polymers (I) having a glass transition temperature T_{g1} to the amount of the one or more polymers (II) having a glass transition temperature T_{g2} is at least 1:2.5 and at most 3.25:1.
[44] The substrate according to any one of embodiments [33] to [43], wherein the one or more polymers (II) having a glass transition temperature T_{g2} comprises
   (B1) one or more olefinically unsaturated monomers, and
   (B2) optionally one or more carboxylic acid functional olefinically unsaturated monomers, different from (B1).
[45] The substrate according to embodiment [44], wherein monomer(s) (B2) if present are selected from the group consisting of itaconic acid, itaconic anhydride, mono-alkylesters of itaconic acid, mono-aryl esters of itaconic acid, acrylic acid, methacrylic acid, β-carboxyethyl acrylate and combinations thereof, more preferably, monomer (B2) is acrylic acid and/or methacrylic acid and most preferably, monomer (B2) is acrylic acid; and/or monomer(s) (B1) are selected from the group consisting of acrylic esters, methacrylic esters, arylalkylenes, itaconic esters and any mixture thereof.
[46] The substrate according to embodiment [44] or [45], wherein at least 30 weight percent, more preferably at least 50 weight percent and even more preferably at least 70 weight percent of the total amount of monomers (B1) is selected from the group consisting of methyl methacrylate, n-butyl acrylate, n-butyl methacrylate, 2-ethyl hexyl acrylate, 2-octyl acrylate, styrene and mixtures of two or more of said monomers.
[47] The substrate according to any one of embodiments [44] to [46], wherein the amount of monomers (B2) in polymer B is at most 3 wt. %, preferably at most 2 wt. % and especially preferably 0 wt. %, and the amount of monomers (B1) is preferably at least 97 wt. %, even more preferably at least 98 wt. % and especially preferably 100 wt. %.
[48] The substrate according to any one of embodiments [44] to [47], wherein (B1) is a combination of one or more acrylic esters and one or more methacrylic esters.
[49] The substrate according to any one of embodiments [33] to [48], wherein the summed amount of the thermally estimated mass content of the one or more polymers having a glass transition temperature T_{g1} and of the thermally estimated mass content of the one or more polymers having a glass transition temperature T_{g2} in the heat resistant coating is at least 40 wt. %, preferably at least 50 wt. %, relative to the total mass of polymers present in the heat resistant coating.
[50] The substrate according to any one of the embodiments [33] to [49], wherein the one or more polymers having a glass transition temperature T_{g2} are prepared in the presence of the one or more polymers having a glass transition temperature T_{g1}.
[51] The substrate according to any one of the embodiments [33] to [50], wherein the substrate is a polymer based substrate and the polymer include one or more polymers selected from the group consisting of polyethylene PE, oriented PE (preferably BOPE), and any combination thereof.
[52] The substrate according to any one of the embodiments [33] to [51], wherein the substrate consists of at least 60 wt. %, preferably of at least 70 wt. %, more preferably of at least 80 wt. % of polymer selected from the group consisting of polyethylene (PE), oriented polyethylene and any combination thereof, based on the total weight of the substrate.
[53] The substrate according to any one of the embodiments [33] to [52], wherein the substrate consists of at least 60 wt. %, preferably of at least 70 wt. %, more preferably at least 80 wt. % of oriented polyethylene, based on the total weight of the substrate.
[54] The substrate according to any one of the embodiments [33] to [53], wherein the substrate consists of at least 60 wt. %, preferably of at least 70 wt. %, more preferably at least 80 wt. % of machine-direction oriented polyethylene, based on the total weight of the substrate.
[55] The substrate according to any one of the embodiments [33] to [54], wherein the substrate consists of at least 60 wt. %, preferably of at least 70 wt. %, more preferably at least 80 wt. % of biaxially oriented polyethylene (BOPE), based on the total weight of the substrate.
[56] The substrate according to any one of embodiments [33] to [55], wherein the heat resistant coating is obtained by (1) disposing an aqueous coating composition on at least a part of the substrate at the side of the substrate that is opposite to the side where the heat sealable area is located, and (2) drying the aqueous coating composition, affording the heat resistant coating on at least a part of the first surface of the substrate.
[57] The substrate according to any one of embodiments [33] to [56], wherein the heat resistant coating has a dry thickness of at least 0.05 μm, preferably of at least 0.1 μm, more preferably of at least 0.25 μm, more preferably of at least 0.4 μm and preferably of at most 25 μm, more preferably of at most 15 μm, more preferably of at most 10 μm, more preferably of at most 8 μm.
[58] The substrate according to any one of embodiments [33] to [57], wherein the heat resistant coating is at least present in the critical areas which come in direct contact with the heat sealing bars and/or hot air during the heat sealing process.
[59] The substrate according to any one of embodiments [33] to [58], wherein the heat sealable area is formed of a polymer, preferably a polyethylene polymer.
[60] The substrate according to any one of embodiments [33] to [59], wherein the substrate is a single layer or includes multiple layers.
[61] The substrate according to any one of embodiments [33] to [60], wherein the heat sealable area is an extruded film or blown film or a coating.
[62] The substrate according to any one of embodiments [33] to [61], wherein the substrate is used to form a packaging article including pouches, bags, and sachets, wherein the heat resistant coating is forming an outermost surface of the packaging article.
[63] A packaging film comprising the coated substrate as defined in any one of embodiments [33] to [62], wherein the coated substrate comprises a heat sealable area that is on the opposite side of the heat resistant coating or wherein the packaging film further comprising one or more additional layers disposed on the second surface of the coated substrate as defined in any one of embodiments [33]to [62] that is on the opposite side of the heat resistant coating, wherein the one or more additional layers comprises a heat sealable are that is on the opposite side of the heat resistant coating.
[64] A packaging article obtained by heat sealing the coated packaging film according to embodiment [63] to a heat sealable substrate, which may be the same coated packaging film or another heat sealable substrate, wherein the heat resistant coating is forming an outermost surface of the packaging article.

The present invention is now illustrated by reference to the following examples. Unless otherwise specified, all parts, percentages and ratios are on a weight basis.

### Method to Calculate the Dry Film Thickness

The dry film thickness is calculated by multiplying the wet film thickness times the solids content of the formulation used.

$$DFT = WFT * solids content / 100$$

### Where

DFT: dry film thickness in μm
WFT: wet film thickness in μm

Solids content (wt. %): total weight of all solid compounds present in formulation divided by (total weight of the formulation*100).

### Measurement Methods

### Average Particle Size PS:

The intensity average particle size, z-average, has been determined by photon correlation spectroscopy using a Malvern Zetasizer Nano ZS. Samples are diluted in demineralized water to a concentration of approximately 0.1 g dispersion/liter. Measurement temperature 25° C. Angle of laser light incidence 173°. Laser wavelength 633 nm.

pH

The pH was measured using a Metrohm pH meter.

### Solids

The solid content of the dispersion was measured on a HB43-S halogen moisture analyzer from Mettler Toledo at a temperature of 130° C.

### Viscosity

The viscosity was determined using a Brookfield LV (spindle 2 at 60 rpm, room temperature)

Determination of Glass Transition Temperatures T_{g1}, T_{g2} Thermally Estimated Mass Content of Polymer(s) with T_{g1} and Thermally Estimated Mass Content of Polymers with T_{g2} and Ratio of Amounts of Polymer(s) with T_{g1} to Amounts of Polymers with T_{g2} Using Differential Scanning Calorimetry (DSC)

Thermal transitions of the samples were investigated by DSC and glass transition temperatures were assigned following ASTM E 1356.

Measurements were conducted with a DSC 250 from TA Instruments; a nitrogen atmosphere was used for all measurements. Indium was used for the enthalpy and temperature calibration of the instrument and an empty Tzero aluminum pan was used as the reference.

Samples of approximately 5 mg were placed in a non-sealed Tzero aluminum pan and dried thoroughly under nitrogen prior to measurement. A drying condition of 180° C. for one hour was used. The weight of the sample was measured after drying, and glass transition temperatures were subsequently determined as described below.

Glass transition temperatures were measured and assigned according to ASTM E 1356. Samples were heated at 10° C./min to 210° C. to remove thermal history, then were cooled at 20° C./min to −90° C. A heating was conducted at 10° C./min from −90° C. to 220° C., which was used for identification of Tg's. As described in ASTM E 1356 and as known to those skilled in the art, other temperature ranges for the heating steps may be required depending on the position of the glass transition temperatures.

Glass transition temperature(s) were assigned using this heating curve, with the midpoint temperature of the transition taken as the value of the T_{g}. In addition, the change in specific heat capacity at each identified glass transition i in the sample, ΔC_{p,i}, has been determined between the extrapolated end temperature and the extrapolated onset temperature of the transition.

It has been assumed that each identified glass transition corresponds to a phase having an intrinsic change in specific heat capacity of

$$Δ {C}_{p}^{0} .$$

Ratio of Amounts of Polymer(s) with T_{g1} to Amounts of Polymer(s) with T_{g2}

To calculate the ratio of amounts of polymer material in phases corresponding to multiple transitions, it has been assumed that the material in each phase has identical intrinsic change in specific heat capacity

$$Δ {C}_{p}^{0} .$$

In the case the sample has a glass transition in the T_{g1} range and a glass transition in the T_{g2} range, the ratio of the amount of the polymer with T_{g1} to the amount of the polymer with T_{g2} is calculated according to the ratio: ΔC_{p,1}:ΔC_{p,2}

In the case of one or more phases n with a T_{g} in the T_{g1} range and one or more phases m with a T_{g} in the T_{g2} range, the ratio of amounts of polymers with a T_{g} in the T_{g1} range to the amounts of polymers with a T_{g} in the T_{g2} range is calculated according to the ratio:

$${\sum }_{n} Δ {C}_{p , 1 , n} : {\sum }_{m} Δ {C}_{p , 2 , m}$$

Thermally Estimated Mass Content of Polymer(s) with T_{g1} and Thermally Estimated Mass Content of Polymer(s) with T_{g2}

The thermally estimated mass content of each phase i in the total sample, mi, is calculated by assuming that each transition has

$$\vert Δ {C}_{p}^{0} \vert = 0.45 J / g - °C .$$

The thermally estimated mass content is then calculated according to mᵢ=|ΔC_{p,i}|/(0.45 J/g-° C.)×100%. In case the thermally estimated mass content is >100%, it is to be rounded to 100%. Because this is an estimated mass content, the sum of thermally estimated mass contents of all phases may be larger than 100%.

Determination of Number Average Molecular Weight, Weight Average Molecular Weight, z-Average Molecular Weight and Molecular Weight Distribution

The number average molecular weight, weight average molecular weight, z-average molecular weight and molecular weight distribution was determined with Size exclusion chromatography in THF HAC 0.8% with two PLgel 10 μm Mixed-C columns at 40° C. on a Waters Alliance 2695 LC system with a Waters 2410 DRI detector. Tetrahydrofuran with 0.8% v/v Acetic acid 100% (THF HAC 0.8%) was used as eluent with a flow of 1 mL/min. The samples are dissolved in the eluent using a concentration of 5 mg polymer per mL solvent. The solubility is judged with a laser pen after 24 hours stabilization at room temperature; if any scattering is visible the samples are filtered first and 150 μl sample solution is injected (0.45 micron PTFE filter). The M_{W} (weight average molecular weight), M_{z} (z-average molecular weight) and MWD (molecular weight distribution) results are calculated with narrow polystyrene standards from 162 to 1.730.000 Da.

### Abbreviations and Raw Materials Used

SGO=Solid Grade Oligomer
kD=kilo Dalton
Mw=weight average molecular weight
Tg=Glass transition temperature
KOH=Potassium hydroxide
BMA=n-Butyl methacrylate
2-EHA=2-Ethylhexyl acrylate
BA=n-Butyl acrylate
i-BMA=i-Butyl methacrylate
mPa·s=milliPascal-second
μm=micrometer
nm=nanometer
PSD=Particle Size Distribution
Dilution water=Demineralized water added when cooling to 25° C.

Solid Grade Oligomers Xiran® 2500, Xiran® 3500, and Xiran® 4000 were supplied by Polyscope.
Solid Grade Oligomer Indurez SR 10 PG was supplied by Indulor.

Xiran® 2500H was supplied by Polyscope as 15 wt % solids solution with pH of 9.1.

### Synthesis of Coating Compositions

### Synthesis of Coating Composition E1

719.17 gram of demineralized water was added to a 4-neck 2-Liter round-bottom glass reactor.

146.91 gram of the Solid Grade Oligomer Xiran® 2500 (supplied by Polyscope) was added under agitation followed by 77.44 gram of ammonia (25% solution in demineralized water). The reactor contents were heated to 85° C. and mixed at 85° C. until the Xiran® 2500 was completely dissolved. Then a nitrogen-flow of 0.2 l/min was started and condenser water was turned on. A solution of 0.64 gram ammonium persulphate dissolved in 1.73 gram demineralized water was added to the reactor in two minutes and the reactor contents were mixed for five minutes. Feeding funnel A was loaded with a mixture of 56.17 gram n-butyl methacrylate and 22.94 gram 2-ethylhexylacrylate. Feeding funnel B was loaded with a solution of 0.64 gram ammonium persulphate dissolved in 18.56 gram demineralized water and 0.09 gram of ammonia (25% solution in demineralized water). The contents of both feeding funnels were added after the five minutes hold to the reactor in 30 minutes at 85° C. Feeding funnel A was rinsed with 4.79 gram demineralized water. The reactor contents were mixed for 30 minutes at 85° C. Then a solution of 0.32 gram ammonium persulphate dissolved in 9.28 gram demineralized water and 0.04 gram of ammonia (25% solution in demineralized water) was added to the reactor in 30 minutes. After the addition, the reactor contents were mixed for 30 minutes. Then 127.00 gram demineralized water was added to the reactor being dilution water and the reactor contents were cooled to 25° C. From a feeding funnel, an amount of 3.69 gram of the biocide Proxel Ultra 10 was added to the reactor in one minute. The feeding funnel was rinsed with 0.42 gram demineralized water. The reactor contents were mixed for 15 minutes and then filtered through a 200 mesh screen.

The solid content of the batch was 19.1% after drying at 130° C. using an IR-dryer. The pH was 9.4 and the Brookfield viscosity 340 mPa·s. The particle size was measured using the Photon Correlation Spectroscopy and a value of 70 nanometer was observed having a particle size distribution of 0.27.

The measured Tg transitions are 180° C. and −16° C. having respectively |ΔC_{p,1}|=0.24 J/g-° C. and |ΔC_{p,2}|=0.14 J/g-° C. The ratio of amounts of polymer with T_{g1}:T_{g2} is therefore 1.7:1 and the thermally estimated mass content of phases with T_{g1} and T_{g2} are respectively 53% and 31%.

### Synthesis of Coating Compositions E2, E3, C1, C2, C3, C4

Additional coating compositions were prepared following the procedure as described for coating composition E1, using the adapted amounts shown in Table 1, keeping remaining synthesis steps otherwise identical. The resulting specifications and measured DSC transitions are shown in Table 1.

TABLE 1

| | E1 | E2 | E3 | C1 | C2 | C3 | C4 |
|---|---|---|---|---|---|---|---|
| Demineralized | 719.17 | 885.47 | 832.10 | 752.80 | 752.80 | 719.17 | 832.12 |
| water (g) | | | | | | | |
| SGO type | Xiran ® 2500 | Xiran ® 3500 | Xiran ® 2500 | Xiran ® 4000 | Indurez | Xiran ® 2500 | Xiran ® 2500 |
| | | | | | SR 10 PG | | |
| Acid Value (mg | 380 | 300 | 380 | 215 | 230 | 380 | 380 |
| KOH/g) | | | | | | | |
| M_{w} (kD) | 30 | 80 | 30 | 10 | 10 | 30 | 30 |
| SGO (g) | 146.91 | 146.91 | 146.91 | 146.91 | 146.91 | 146.91 | 146.91 |
| Ammonia (25% | 77.44 | 73.24 | 77.41 | 61.41 | 53.81 | 77.41 | 77.41 |
| solution in | | | | | | | |
| demineralized | | | | | | | |
| water) (g) | | | | | | | |
| Monomers | | | | | | | |
| BMA (g) | 56.17 | 56.17 | 56.17 | 56.17 | 56.17 | 0 | 0 |
| 2-EHA (g) | 22.94 | 22.94 | 0 | 22.94 | 22.94 | 0 | 0 |
| BA (g) | 0 | 0 | 22.94 | 0 | 0 | 6.33 | 0 |
| Styrene (g) | 0 | 0 | 0 | 0 | 0 | 72.78 | 0 |
| i-BMA (g) | 0 | 0 | 0 | 0 | 0 | 0 | 79.11 |
| Dilution water (g) | 127.00 | 0 | 0 | 0 | 0 | 225.00 | 0 |
| Specifications | | | | | | | |
| pH | 9.4 | 9.4 | 9.0 | 9.5 | 9.0 | 9.1 | 9.0 |
| Brookfield | 340 | 125 | 160 | 36 | 6 | 485 | 463 |
| viscosity (mPa · s) | | | | | | | |
| Solids (%) | 19.1 | 18.8 | 19.0 | 21.1 | 20.8 | 17.5 | 19.8 |
| Particle Size (nm) | 70 | 51 | 70 | 63 | 56 | 95 | 63 |
| PSD | 0.27 | 0.52 | 0.25 | 0.20 | 0.03 | 0.34 | 0.24 |
| DSC Transitions | | | | | | | |
| T_{g1} (° C.) | 180 | 168 | 178 | 139 | 126 | 184 | 181 |
| T_{g2} (° C.) | −16 | −5 | −5 | 3 | −19 | 89 | 60 |
| \|ΔC_{p, 1}\| (J/g-° C.) | 0.24 | 0.15 | 0.24 | 0.19 | 0.28 | 0.30 | 0.22 |
| \|ΔC_{p, 2}\| (J/g-° C.) | 0.14 | 0.10 | 0.08 | 0.11 | 0.14 | 0.10 | 0.08 |

### Synthesis of Coating Composition E4

603.42 gram of demineralized water was added to a 4-neck 2-Liter round-bottom glass reactor.

102.84 gram of the Solid Grade Oligomer Xiran® 2500 (supplied by Polyscope) was added under agitation followed by 54.21 gram of ammonia (25% solution in demineralized water). The reactor contents were heated to 85° C. and mixed at 85° C. until the Xiran® 2500 was completely dissolved. Then a nitrogen-flow of 0.2 l/min was started and condenser water was turned on. A solution of 1.55 gram ammonium persulphate dissolved in 4.18 gram demineralized water and 0.21 gram of ammonia (25% solution in demineralized water) was added to the reactor in two minutes and the reactor contents were mixed for five minutes. Feeding funnel A was loaded with a mixture of 135.60 gram n-butyl methacrylate and 55.38 gram 2-ethylhexylacrylate. Feeding funnel B was loaded with a solution of 1.55 gram ammonium persulphate dissolved in 44.95 gram demineralized water and 0.21 gram of ammonia (25% solution in demineralized water). The contents of both feeding funnels were added after the five minutes hold to the reactor in 75 minutes at 85° C. After 50 minutes feeding, every five minutes an amount of 25 gram demineralized water was added. Feeding funnel A was rinsed with 11.57 gram demineralized water. The reactor contents were mixed for 30 minutes at 85° C. Then a solution of 0.77 gram ammonium persulphate dissolved in 22.48 gram demineralized water and 0.11 gram of ammonia (25% solution in demineralized water) was added to the reactor in 30 minutes. After the addition, the reactor contents were mixed for 30 minutes. Then the reactor contents were cooled to 25° C. From a feeding funnel, an amount of 2.58 gram of the biocide Proxel Ultra 10 was added to the reactor in one minute. The feeding funnel was rinsed with 0.29 gram demineralized water. The reactor contents were mixed for 15 minutes and then filtered through a 200 mesh screen.

The solid content of the batch was 24.5% after drying at 130° C. using an IR-dryer. The pH was 8.8 and the Brookfield viscosity 33 mPa·s. The particle size was measured using the Photon Correlation Spectroscopy and a value of 139 nanometer was observed having a particle size distribution of 0.28.

### Synthesis of Coating Composition C5

526.96 gram of demineralized water was added to a 4-neck 2-Liter round-bottom glass reactor.

102.84 gram of the Solid Grade Oligomer Indurez SR 10 PG (supplied by Indulor) was added under agitation followed by 40.67 gram of ammonia (25% solution in demineralized water). The reactor contents were heated to 85° C. and mixed at 85° C. until the Indurez SR 10 PG was completely dissolved. Then a nitrogen-flow of 0.2 l/min was started and condenser water was turned on. A solution of 1.55 gram ammonium persulphate dissolved in 4.18 gram demineralized water and 0.21 gram of ammonia (25% solution in demineralized water) was added to the reactor in two minutes and the reactor contents were mixed for five minutes. Feeding funnel A was loaded with a mixture of 135.60 gram n-butyl methacrylate and 55.38 gram 2-ethylhexylacrylate. Feeding funnel B was loaded with a solution of 1.55 gram ammonium persulphate dissolved in 44.95 gram demineralized water and 0.21 gram of ammonia (25% solution in demineralized water). The contents of both feeding funnels were added after the five minutes hold to the reactor in 75 minutes at 85° C. Feeding funnel A was rinsed with 11.57 gram demineralized water. The reactor contents were mixed for 30 minutes at 85° C. Then a solution of 0.77 gram ammonium persulphate dissolved in 22.48 gram demineralized water and 0.11 gram of ammonia (25% solution in demineralized water) was added to the reactor in 30 minutes. After the addition, the reactor contents were mixed for 30 minutes. Then the reactor contents were cooled to 25° C. From a feeding funnel, an amount of 2.58 gram of the biocide Proxel Ultra 10 was added to the reactor in one minute. The feeding funnel was rinsed with 0.29 gram demineralized water. The reactor contents were mixed for 15 minutes and then filtered through a 200 mesh screen.

The solid content of the batch was 31.2% after drying at 130° C. using an IR-dryer. The pH was 8.6 and the Brookfield viscosity 9 mPa·s. The particle size was measured using the Photon Correlation Spectroscopy and a value of 55 nanometer was observed having a particle size distribution of 0.10.

The compositions and specifications of coating compositions E4 and C5 are summarized in Table 2, together with measured DSC transitions.

TABLE 2

| | E4 | C5 |
|---|---|---|
| Demineralized water (g) | 603.42 | 526.96 |
| SGO type | Xiran ® 2500 | Indurez SR 10 PG |
| Acid Value (mg KOH/g) | 380 | 230 |
| Mw (kD) | 30 | 10 |
| SGO (g) | 102.84 | 102.84 |
| Ammonia (25% solution in | 54.21 | 40.67 |
| demineralized water) (g) | | |
| Monomers | | |
| BMA (g) | 135.60 | 135.60 |
| 2-EHA (g) | 55.38 | 55.38 |
| Specifications | | |
| pH | 8.8 | 8.6 |
| Brookfield viscosity (mPa · s) | 33 | 9 |
| Solids (%) | 24.5 | 31.2 |
| Particle Size (nm) | 139 | 55 |
| Particle size distribution | 0.28 | 0.10 |
| DSC Transitions | | |
| T_{g1} (° C.) | 180 | 135 |
| T_{g2} (° C.) | −5 | −10 |
| \|ΔC_{p, 1}\| (J/g-° C.) | 0.13 | 0.12 |
| \|ΔC_{p, 2}\| (J/g-° C.) | 0.20 | 0.22 |

### Coating Composition C6

Coating composition C6 consists of Xiran® 2500H obtained from Polyscope as 15 wt % solids solution with pH of 9.1. This sample has a single measured Tg transition of 185° C. having |ΔC_{p,1}|=0.43 J/g-° C.

### Preparation of Coating Composition E5

Synthesis of an Acrylic Binder that is Part of Coating Composition E5

950.20 gram of demineralized water was added to a 4-neck 2-Liter round-bottom glass reactor. Under agitation, 33.17 gram of Sodium Lauryl Sulphate (supplied as 30% solution in water) was added to the reactor. The reactor contents were heated to 80° C. Then a nitrogen-flow of 0.2 l/min was started and condenser water was turned on. A feeding funnel A was loaded with a mixture of 190.23 gram methyl methacrylate, 233.46 gram n-butyl acrylate and 8.65 gram methacrylic acid. Feeding funnel B was loaded with a solution of 2.17 gram ammonium persulphate dissolved in 7.50 gram demineralized water. An amount of five weight % of the contents of feeding funnel A was added to the reactor in one minute, directly followed by the complete contents of feeding funnel B in three minutes. The reactor contents were mixed for 10 minutes allowing to reactor temperature to increase to 85° C. Then the remainder of feeding funnel A was added to the reactor in 60 minutes whilst keeping the temperature at 83 to 87° C. Feeding funnel A was rinsed with 7.50 gram demineralized water. The reactor contents were mixed for 60 minutes at 83 to 87° C. The reactor contents were then cooled to 25° C. Then 6.79 gram of ammonia (25% solution in demineralized water) was added to the reactor. From a feeding funnel, an amount of 9.00 gram of the biocide Proxel Ultra 10 was added to the reactor in one minute. The feeding funnel was rinsed with 1.87 gram demineralized water. The reactor contents were mixed for 15 minutes and then filtered through a 200 mesh screen. The solid content of the batch was 30.0% after drying at 160° C. using an IR-dryer. The pH was 8.3 and the Brookfield viscosity was 10 mPa·s. The particle size was measured using the Photon Correlation Spectroscopy and a value of 44 nanometer was observed having a particle size distribution of 0.04.

Coating composition E5 was prepared by blending 16.0 grams of the acrylic binder prepared as described above with 30.0 grams of Xiran® 2500H solution in a glass vessel stirred for 15 minutes at room temperature.

The measured T_{g} transitions are 185° C. and 21° C. having respectively |ΔC_{p,1}|=0.17 J/g-° C. and |ΔC_{p,2}|=0.21 J/g-° C. The ratio of amounts of polymer with T_{g1}:T_{g2} is therefore 0.81:1 and the thermally estimated mass content of phases with T_{g1} and T_{g2} are respectively 38% and 47%.

### Preparation of Heat-Sealable Film

A heat-sealable film, composed of majority oriented polyethylene, was prepared by laminating Silvalac PS525 heat-sealable blown PE film of 30 μm thickness, obtained from Silvalac, onto Ethy-Lyte™ 20HD200 BOPE film obtained from Jindal, using as lamination adhesive Novacote NC-275-A with co-reactant CA-12 obtained from Coim, applied at 2.5 g/m² solids and cured for 48 hours at room temperature. The “treated” surface of the BOPE film (as indicated by supplier) was positioned to form the exterior surface of the film, opposing the heat-sealable blown PE surface.

Immediately prior to application of (inventive and comparative) coating compositions onto this heat-sealable film, the exterior BOPE surface was corona-treated. The coating compositions were diluted with water to 15 wt. % solids and then applied on the exterior BOPE surface by wirebar at 24 μm wet thickness. The coatings were dried in a hot air oven for 20 seconds at 80° C., and allowed to rest at room temperature for at least 24 hours. Samples were cut with a Brugger strip cutter STR intro strips with a width of 15 mm and length of approximately 250 mm.

### Testing of Heat Resistance Performance

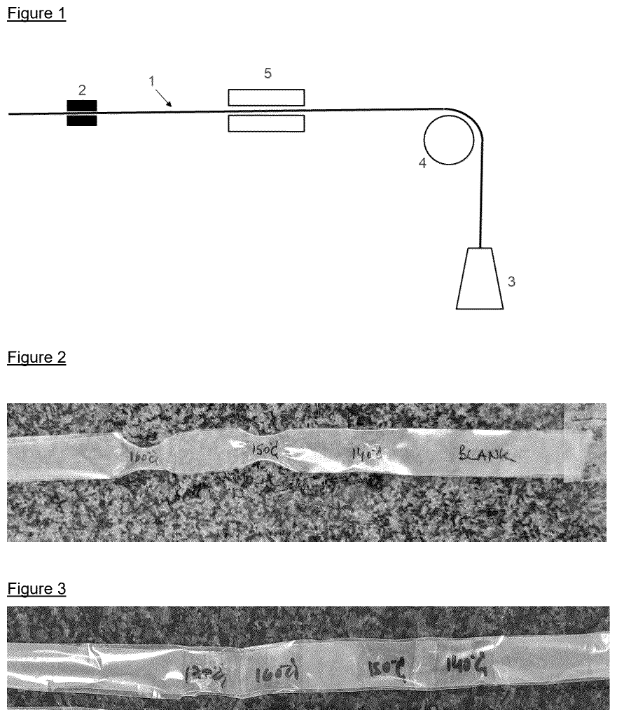

For heat resistance testing of coated samples as well as uncoated reference substrate (Comparative Experiment A), two identical sample strips were stacked with the heat-sealable blown PE surfaces in contact, and the coated surfaces or uncoated BOPE surfaces oriented towards the exterior, to form a stacked specimen for testing. A Brugger HSG-CC laboratory hot jaw sealer with Hot Tack device was then used to perform a heat seal operation while the specimen was held under tension, in a configuration illustrated schematically in FIG. 1. One end of the stacked specimen (1) is clamped into the clamp (2) of the Hot Tack device and the other end of the stacked specimen is clamped into a single 50 gram drop weight (3). The specimen is positioned hanging over the cylindrical mandrel (4) of the Hot Tack device, such that a heat seal operation can be performed with the heat sealing jaws (5) on the tensioned area of the specimen between the clamp (2) and the mandrel (4).

FIG. 1: Schematic illustration of test configuration for testing heat resistance performance of samples.

1. Test specimen (composed of two stacked sample strips as described above)
2. Clamp of Hot Tack device
3. Drop weight
4. Cylindrical mandrel of Hot Tack device
5. Heat sealing jaws (long dimension of jaws are oriented perpendicular to long dimension of test specimen)

The heat seal testing was executed with two teflonized sealing jaws (40 mm×20 mm dimensions). The lower jaw was unheated, and the upper jaw was heated to a set temperature. Heat sealing was executed with conditions of 0.4 second sealing time and 780 Newton applied force. Heat sealing was first applied with a heated jaw temperature set to 140° C. Further tests were then executed, re-positioning the stacked specimen in the Hot Tack device clamp to apply the heat seal to a new area of the specimen (or using a fresh pair of sample strips as a new test specimen), and progressively increasing the heated jaw temperature in 10° C. increments, until visual deformation/damage such as melting, sticking, shrinkage, stretching, or breakage of the specimen was observed after sealing. The formation of a heat seal bonding the two sample strips was checked by visual and physical inspection.

Examples of the invention show an increase in the temperature at which visual deformation/damage occurs, while also not preventing a heat seal from forming.

### COMPARATIVE EXPERIMENT A

In Comparative Experiment A, no coating was applied on the heat-sealable film, which was then tested as an uncoated (“blank”) sample. FIG. 2 shows the result of heat-sealing this sample as described with jaw temperatures of 140° C., 150° C. and 160° C. Stretching and deformation occur upon heat sealing at temperatures of 150° C. and higher. For coated samples, 140° C. is therefore used as the reference temperature for calculation of the increase in temperature resistance.

### EXAMPLES 1-5

In Example 1, the heat-sealable film was coated as described with coating composition E1, and the heat resistance performance was tested as described above. In FIG. 3, a photo is shown of the sample after testing. At 150° C. and 160° C. jaw temperatures the sample does not deform, unlike the uncoated reference substrate. At 170° C., deformation and shrinkage is visible. Because the sample is able to resist temperature of 160° C., this example has an increase of temperature resistance of +20° C. relative to the uncoated reference.

In Examples 2-5, the heat sealable film was coated as described above with coating compositions E2-E5, and the heat resistance performance was tested as described above.

In Examples 2 and 3, the coated films were found to have an increase of temperature resistance of +20° C. In Example 4 and 5, the coated films were found to have an increase of temperature resistance of +10° C.

The heat resistance results of Examples 1-5 are reported in Table 3.

TABLE 3

| | Exam- | Exam- | Exam- | Exam- | Exam- |
|---|---|---|---|---|---|
| | ple 1 | ple 2 | ple 3 | ple 4 | ple 5 |
| Coating | E1 | E2 | E3 | E4 | E5 |
| Composition | | | | | |
| High-T_{g} Phase | | | | | |
| Measured T_{g} | 180 | 168 | 178 | 180 | 185 |
| of SGO (° C., | | | | | |
| DSC) (T_{g1}) | | | | | |
| Low-Tg Phase | | | | | |
| Measured T_{g} | −16 | −5 | −5 | −5 | 21 |
| of low-T_{g} | | | | | |
| phase (T_{g2}) | | | | | |
| Ratio of | 1.7:1 | 1.5:1 | 3.0:1 | 0.65:1 | 0.81:1 |
| amount of T_{g1} | | | | | |
| polymer:amount | | | | | |
| of T_{g2} polymer | | | | | |
| Thermally | 53% | 33% | 53% | 29% | 38% |
| estimated | | | | | |
| mass content | | | | | |
| T_{g1} polymer | | | | | |
| Thermally | 31% | 22% | 18% | 44% | 47% |
| estimated | | | | | |
| mass content | | | | | |
| T_{g2} polymer | | | | | |
| T_{g} Difference | 196 | 173 | 183 | 185 | 164 |
| (° C.) | | | | | |
| Heat | | | | | |
| Resistance | | | | | |
| Testing | | | | | |
| Increase in | +20° C. | +20° C. | +20° C. | +10° C. | +10° C. |
| Temperature | | | | | |
| Resistance | | | | | |

### COMPARATIVE EXPERIMENTS B-G

For Comparative Experiments B-G, coating compositions C1-C6 respectively were applied onto the heat sealable film as described, and the heat resistance performance was tested as described above. In all cases, no increase in temperature resistance was observed relative to the uncoated substrate. The heat resistance testing results of Comparative Experiments B-G are reported in Table 4.

TABLE 4

| | Comp | Comp | Comp | Comp | Comp | Comp |
|---|---|---|---|---|---|---|
| | B | C | D | E | F | G |
| Coating | C1 | C2 | C3 | C4 | C5 | C6 |
| Composition | | | | | | |
| High-T_{g} Phase | | | | | | |
| Measured T_{g} | 139 | 126 | 184 | 181 | 135 | 185 |
| of SGO (° C., | | | | | | |
| DSC) (T_{g1}) | | | | | | |
| Low-Tg Phase | | | | | | |
| Measured T_{g} | 3 | −19 | 89 | 60 | −10 | n/a |
| of low-T_{g} | | | | | | |
| phase (T_{g2}) | | | | | | |
| Ratio of | 1.7:1 | 2.0:1 | 3.0:1 | 2.8:1 | 0.55:1 | n/a |
| amount of T_{g1} | | | | | | |
| poly- | | | | | | |
| mer:amount | | | | | | |
| of T_{g2} polymer | | | | | | |
| Thermally | 42% | 62% | 67% | 49% | 27% | 96% |
| estimated | | | | | | |
| mass content | | | | | | |
| T_{g1} polymer | | | | | | |
| Thermally | 24% | 31% | 22% | 18% | 49% | n/a |
| estimated | | | | | | |
| mass content | | | | | | |
| T_{g2} polymer | | | | | | |
| T_{g} Difference | 136 | 145 | 95 | 121 | 145 | n/a |
| (° C.) | | | | | | |
| Heat | | | | | | |
| Resistance | | | | | | |
| Testing | | | | | | |
| Increase in | 0° C. | 0° C. | 0° C. | 0° C. | 0° C. | 0° C. |
| Temperature | | | | | | |
| Resistance | | | | | | |

Comparative B has a coating composition with T_{g1} of 139° C., Comparative F has a coating composition with T_{g1} of 135° C., and Comparative C has a coating composition with T_{g1} of 126° C. Comparatives B, F and C all illustrate that a sufficiently high T_{g1} is necessary in order to achieve an increase in temperature resistance.

Comparative D has a coating composition with T_{g2} of 89° C., and a T_{g} difference of 95° C. Comparative E has a T_{g2} of 60° C. Comparative G has a coating composition which consists only of a high-T_{g} phase, and has no low-T_{g} phase and no measurable T_{g2}. None of these comparative examples show any increase in heat resistance. Comparatives D, E and G illustrate the surprising finding that in addition to a high-T_{g} polymer phase, the presence of a low-T_{g} polymer phase in the heat resistant coating is also necessary to increase the temperature resistance of the coated substrate. The low-T_{g} phase should have T_{g2} not too high, and a sufficiently large difference with T_{g1}, as illustrated by Comparatives D and E.

1. A coated packaging film comprising:
(1) A heat sealable substrate having a heat sealable area and an opposite surface that is on the opposite side to the heat sealable area,
(2) A heat resistant coating disposed on at least a part of said opposite surface of the substrate,
wherein the heat resistant coating comprises:
(I) One or more polymers (I) having a glass transition temperature T_{g1} of at least 140° C., and
(II) One or more polymers (II) having a glass transition temperature T_{g2} of at most 50° C.,
wherein the difference between T_{g1} and T_{g2} is at least 100° C.,
wherein the T_{g1} and T_{g2} are determined with Differential Scanning Calorimetry as described in the description, and
wherein the substrate consists of at least 60 wt. % of polymer selected from the group consisting of polyethylene, oriented polyethylene and any combination thereof, based on the total weight of the substrate.

2. The packaging film according to claim 1, wherein the thermally estimated mass content of the one or more polymers (I) having a glass transition temperature T_{g1}, relative to the total mass of polymers present in the heat resistant coating, is at least 7.5 wt. %, and the thermally estimated mass content of the one or more polymers (I), relative to the total mass of polymers present in the heat resistant coating, is at most 85 wt. %, wherein the thermally estimated mass content of the one or more polymers with T_{g1} is determined with the method as described in the description.

3. The packaging film according to claim 1, wherein the thermally estimated mass content of the one or more polymers (I) having a glass transition temperature T_{g1}, relative to the total mass of polymers present in the heat resistant coating, is at least 15 wt. %.

4. The packaging film according to claim 1, wherein the one or more polymers (I) having a glass temperature T_{g1} of at least 142° C.

5. The packaging film according to claim 1, wherein the one or more polymers (I) are or are derived from a polymer comprising:
one or more monomers (A1) selected from the group consisting of styrene, substituted styrene, acrylic esters, methacrylic esters and itaconic esters, and one or more monomers (A2) selected from the group consisting of acrylic acid, β-carboxy ethylacrylate, methacrylic acid, maleic acid, maleic anhydride and itaconic acid.

6. The packaging film according to claim 1, wherein the one or more polymers (I) are or are derived from styrene/maleic anhydride (SMA) copolymers.

7. The packaging film according to claim 1, wherein the difference between T_{g1} and T_{g2} is at least 110° C., and at most 320° C.

8. The packaging film according to claim 1, wherein T_{g2} is at least −60° C., and preferably at most 40° C.

9. The packaging film of claim 1, wherein
the thermally estimated mass content of the one or more polymers (II) having a glass transition temperature T_{g2}, relative to the total mass of polymers present in the heat resistant coating, is at least 15 wt. %, and the thermally estimated mass content of the one or more polymers (II) having a glass transition temperature T_{g2}, relative to the total mass of polymers present in the heat resistant coating, is at most 90 wt. %, wherein the thermally estimated mass content of the one or more polymers with T_{g2} is determined with the method as described in the description.

10. The packaging film according to claim 1, wherein the ratio of the amount of the one or more polymers (I) having a glass transition temperature T_{g1} to the amount of the one or more polymers (II) having a glass transition temperature T_{g2} is at least 1:5, wherein said ratio is determined with the method as described in the description.

11. The packaging film according to claim 1, wherein
(i) the one or more polymers (I) having a glass temperature T_{g1} of at least 150° C. and of at most 210° C.,
(ii) the thermally estimated mass content of the one or more polymers (I), relative to the total mass of polymers present in the heat resistant coating, is at least 25 wt. % and at most 80 wt. %,
(iii) the one or more polymers (II) having a glass temperature T_{g2} of at least −30° C. and of at most 30° C.,
(iv) the thermally estimated mass content of the one or more polymers (II), relative to the total mass of polymers present in the heat resistant coating, is at least 15 wt. % and at most 50 wt. %,
(v) the difference between T_{g1} and T_{g2} is at least 120° C. and at most 220° C., and
(vi) the ratio of the amount of the one or more polymers (I) having a glass transition temperature T_{g1} to the amount of the one or more polymers (II) having a glass transition temperature T_{g2} is at least 1:2.5 and at most 3.25:1.

12. The packaging film according to claim 1, wherein the one or more polymers (II) having a glass transition temperature T_{g2} comprises
(B1) olefinically unsaturated monomer, and
(B2) optionally carboxylic acid functional olefinically unsaturated monomer, different from (B1).

13. The packaging film according to claim 12, wherein (B1) is a combination of one or more acrylic esters and one or more methacrylic esters.

14. The packaging film according to claim 1, wherein the one or more polymers having a glass transition temperature T_{g2} are prepared in the presence of the one or more polymers having a glass transition temperature T_{g1}.

15. The packaging film according to claim 14, wherein T_{g2} is at most 20° C.

16. The packaging film according to claim 1, wherein the summed amount of the thermally estimated mass content of the one or more polymers having a glass transition temperature T_{g1} and of the thermally estimated mass content of the one or more polymers having a glass transition temperature T_{g2} in the heat resistant coating is at least 40 wt. %, relative to the total mass of polymers present in the heat resistant coating.

17. The packaging film according to claim 1, wherein the substrate consists of at least 70 wt. % of polymer selected from the group consisting of polyethylene PE, oriented polyethylene and any combination thereof, based on the total weight of the substrate.

18. The packaging film according to claim 1, wherein the substrate consists of at least 60 wt. % of oriented polyethylene, based on the total weight of the substrate.

19. The packaging film according to claim 1, wherein the substrate consists of at least 60 wt. % of machine-direction oriented polyethylene, based on the total weight of the substrate.

20. The packaging film according to claim 1, wherein the substrate consists of at least 60 wt. % of biaxially oriented polyethylene (BOPE), based on the total weight of the substrate.

21-23. (canceled)
